(19) United States
(12) Patent Application Publication
(10) Pub. No.: US 2005/0052699 A1
(43) Pub. Date: Mar. 10, 2005

(54) Purging print jobs

(76) Inventor: Joe F. Goicoechea, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/657,877

(22) Filed: Sep. 9, 2003

(51) Int. Cl. G06F 15/00

(52) U.S. Cl. 358/1.16; 358/1.1

(57) ABSTRACT

Purging time sensitive print jobs. A method embodiment includes storing a print job in memory, identifying a printer malfunction that prevents the stored print job from being printed. Upon identifying a malfunction, it is determined if a stored print job has expired. If expired the print job is purged from the memory.

### BACKGROUND

Many conventional printers have internal memory to temporarily store print jobs as they are being printed. At one time or another, a printer may suffer from a malfunction such as a paper jam that renders the printer unavailable for printing. Such a malfunction can occur after completing a job, between print jobs, or while a print job is being printed.

Historically, when a malfunction occurred while a print job was being processed—that is, as a page is being printed—that page and any remaining pages would have to be reprinted. This required a user to return to their computer and issue another print command for those pages. To avoid this inconvenience, a number of printers are equipped with a recovery feature. The recovery feature ensures that print job data for unprinted and unsuccessfully printed pages is retained in memory, so that after a malfunction is remedied, printing can resume and all pages can be printed.

Recovery of a print job in this manner may, however, create a problem. For example, often printer malfunctions are remedied by service technicians and others who may not have clearance to view sensitive materials. Once the technician remedies a malfunction, the recovery feature causes additional pages to be printed potentially exposing sensitive or otherwise confidential materials. One possible solution involves disabling the recovery feature. However, with the recovery feature disabled, remedying a printer malfunction often erases the printer's memory. Consequently, a partially printed print job may need to be reprinted thereby inconveniencing the user.

### DESCRIPTION OF THE DRAWINGS

FIG. 1 is a depiction of an environment in which various embodiment of the present invention may be implemented.

FIG. 2 is a block diagram illustrating the logical components according to an embodiment of the present invention.

FIG. 3 is a flow diagram illustrating the steps taken to protect sensitive documents according to an embodiment of the present invention.

FIG. 4 is an exemplary screen view of a user interface having controls for identifying a print job as time sensitive and for setting expiration data according to an embodiment of the present invention.

### DETAILED DESCRIPTION

INTRODUCTION: According to one illustrative embodiment, a print job can be identified as time sensitive. When a printer malfunction prevents the print job from being printed, the time sensitive print job can be recognized and purged from memory if a printer malfunction is not remedied within a pre-defined time or within a set time defined by a user. Print jobs not identified as time sensitive are not affected.

The phrase time sensitive, as used here and in the claims that follow, has no bearing on the actual contents of the print job. The print job may or may not be confidential in nature. Identifying a print job as time sensitive only represents a desire that the print job be subject to deletion from memory before it has been completely printed.

The term memory as it relates to memory holding a print job refers generally to any memory that at least temporarily holds any portion of a print job. Two examples include a print queue providing a holding bin for multiple print jobs directed to a printer and the printer's own memory used when printing a print job.

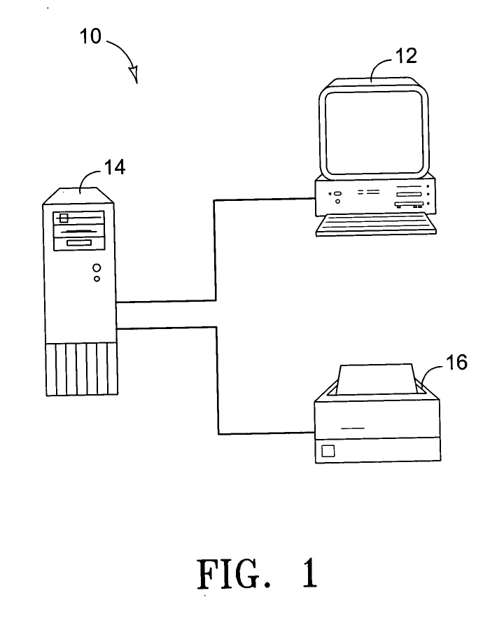

ENVIRONMENT: FIG. 1 illustrates an environment 10 in which it would be advantageous to implement embodiments of the present invention. As depicted in FIG. 1, environment 10 includes computer 12 for sending print jobs to server 14. Server 14 is responsible for queuing and routing print jobs to printer 16. Printer 16 represents generally any image forming device capable of printing. A print queue providing a holding bin for print jobs can reside in printer 16 and/or in server 14. Computer 12 may also send print jobs directly to printer 16 bypassing server 14.

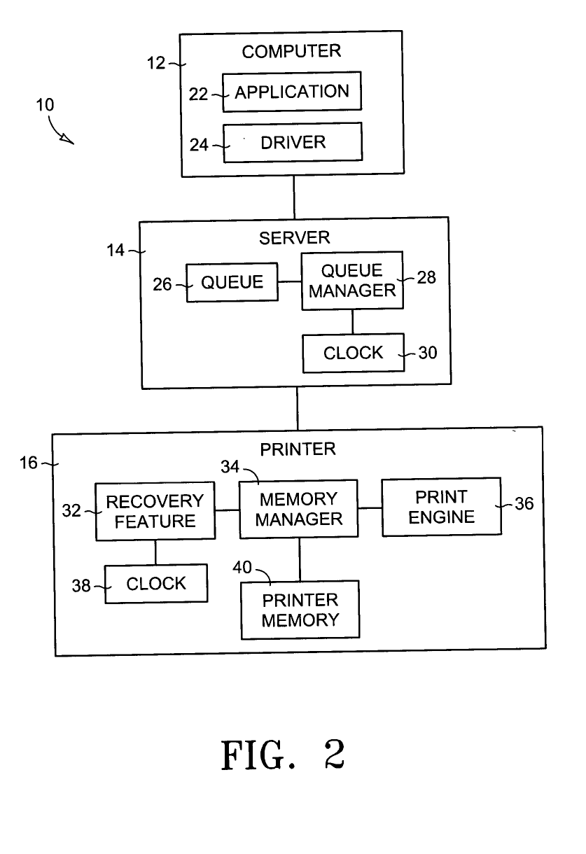

COMPONENTS: The physical and logical components of one embodiment of the invention will now be described with reference to the block diagram of FIG. 2. Computer 12 includes application 22 and driver 24. Application 22 represents any programming capable of instructing that an electronic document be printed. For example, application 22 may be a word processor or other desktop publishing application. Driver 24 provides programming for translating printing instructions from application 22 into device-specific instructions (print jobs) for printing. Driver 24 is also responsible for generating and/or presenting a user interface that allows the user to specify that a print job is to be designated as “time sensitive” and to associate expiration data with that print job. Selections made through the interface are made part of a print job. For example, the print job will include data defining the document to be printed. It also can include formatting instructions for printing multiple copies, duplexing, binding, and/or sorting. In addition to these formatting instructions, the print job can include a time sensitivity designation and, if needed, expiration data.

Expiration data is data specifying one or more durations used to determine whether a sensitive print job has expired. Driver 24, for example, may allow a user to specify a value or values such as five, or ten minutes for the expiration data. If a user does not specify values, driver 24 may set default values. A given value might indicate how long a print job is to be held in a print queue and/or in printer memory once a malfunction is detected. Another value might indicate how long a print job is to be held in a print queue without regard to the existence of a malfunction. In short, a print job expires when an elapsed time following a triggering event exceeds a duration specified by expiration data for the print job. A triggering event can be any detectable event. One example, (of many possible examples) include the occurrence of a malfunction that prevents, at least temporarily, the print job from being delivered to or printed by an image forming device. Another example includes the placement of the print job in a print queue—sometimes referred to as queuing the print job.

For example, if a printer malfunctions and a time sensitive print job is held in the printer's memory, expiration data may indicate that the time sensitive print job is to be purged from the printer's memory if the malfunction is not remedied within a first duration. If a printer malfunctions and a time sensitive print job is held in a queue, the expiration data may indicate that the time sensitive print job is to be purged from the queue if the malfunction is not remedied within a second duration. If a time sensitive print job has been held in a queue for an extended period, expiration data may indicate that the time sensitive print job is to be purged from the queue if the time sensitive print job has been held for a period that exceeds a third duration. The first, second and third durations may be the same or different values.

Server 14 includes queue 26, a queue manager 28, and server clock 30 for providing timing information. Queue 26 represents any memory for temporarily storing a plurality of print jobs directed to printer 16. Queue manager 28 represents any programming capable of managing queue 26. Managing functions include:
periodically releasing print jobs from queue 26 as printer 16 becomes available to print;
identifying a triggering event;
identifying time sensitive print jobs and associated expiration data; and
purging time sensitive print jobs that have expired.
   Queue manager 28 communicates with clock 30 to identify a time elapsed following the occurrence of a triggering event such as a printer malfunction and/or the placement of the print job in queue 26. Queue manager 28 compares the time elapsed with the expiration data for each time sensitive print job. A time sensitive print job can be said to have expired when the time elapsed exceeds a duration indicated by the expiration data of that print job. In the event the time sensitive print job has expired and is purged, queue manager 28 generates and sends a message to computer 12 to inform a user that the print job was deleted and may be resent for printing.

Printer 16 includes recovery feature 32, memory manager 34, print engine 36, printer clock 38, and printer memory 40. Printer memory 40 represents one or more memory devices used to store a print job or portions thereof. Printer memory can store the print job temporarily as it is being printed or more permanently so the print job can be retrieved and reprinted without being resent to printer. Recovery feature 32 represents generally any programming capable of directing memory manager 34 to retain or purge print job data in printer memory 40. Memory manager 34 represents any programming capable of storing a print job in printer memory 40 and passing a print job from printer memory 40 to print engine 36. Memory manager 34 is also responsible for purging print job data from printer memory 40 as that data is successfully printed or as directed by recovery feature 32. Print engine 36 represents any combination of hardware and programming capable of producing a print job on paper or other print media.

Recovery feature 32 is responsible for detecting the occurrence of a triggering event. For example recovery feature 32 may be responsible for monitoring the status of print engine 36 to identify malfunctions. When a triggering event such as a malfunction is detected, recovery feature 32 identifies whether a print job held in printer memory 40 is time sensitive or not. If identified as time sensitive, recovery feature 32 obtains expiration data for the print job, communicates with clock 38 to identify a time elapsed since the occurrence of the triggering event and compares the time elapsed to the expiration data for the time sensitive print job. A time sensitive print job can be said to have expired when the time elapsed exceeds the duration indicated by the expiration data. If it is determined that a time sensitive print job has expired, recovery feature 32 directs memory manager 34 to purge that print job from printer memory 40

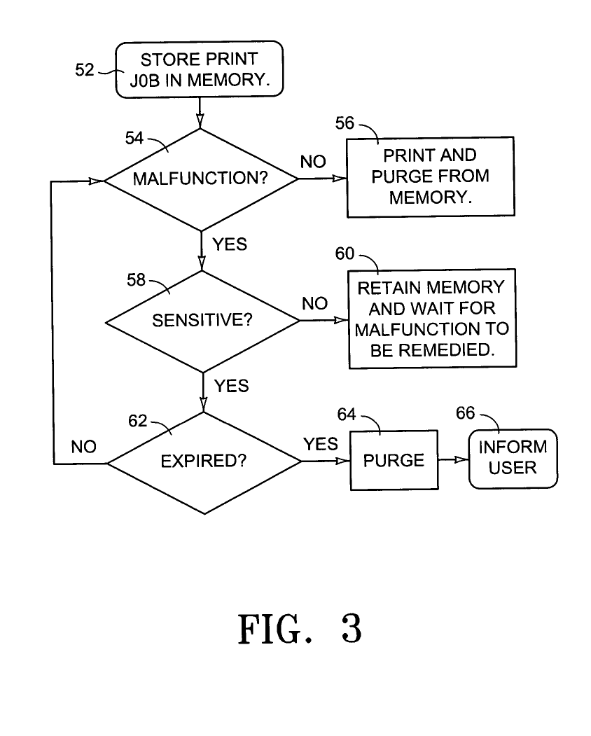

OPERATION: The flow chart of FIG. 3 helps to illustrate steps taken to provide a more secure printing method according to an embodiment of the present invention. The flow chart depicts the logical steps that a print job follows for printing, where the print job will undergo holding, assessment and processing steps based on print job parameters, time elapsed, and the printer's operational status.

A print job is stored in memory (step 52). The memory, for example, may be printer memory 40 or print queue 26. It is then assessed whether a triggering event has occurred—that is, in this example—whether a malfunction exists (step 54). If the answer to the assessment in step 54 is NO, the print job is printed and purged from memory (step 56). However, if the answer to the assessment in step 54 is YES, it is then assessed whether the print job is “time sensitive” (step 58). If the answer to the assessment in step 58 is NO, the print job is retained in memory to wait for the malfunction to be remedied (step 60). However, if the answer to the assessment to step 58 is YES, it is then determined whether the print job has expired (step 62).

To determine if a print job has expired, the duration of the malfunction can be compared to the expiration data for the print job. If the malfunction duration exceeds a duration indicated by the expiration data, the print job has expired. If the answer to the determination in step 62 is NO, the process repeats with step 54. However, if the answer to the determination in step 62 is YES, the print job is purged from memory (step 64) and a user is informed that the print job has been purged and must be resent for printing (step 66).

The steps of FIG. 3 can be employed to queue 26 and queue manager 28 depicted in FIG. 2. For example, mentioned here but not depicted in the figures, a print job is stored in queue 26 (step 52) as queue manager 28 assesses printer 16 for malfunction (step 54). If the assessment reveals printer 16 to be operative, the print job is sent to printer memory 40 for processing, and purged from queue 26 (step 56). However if printer 16 is assessed to be malfunctioning, queue manager 28 determines whether or not the queued print job is time sensitive (step 58). If not time sensitive, the print job is retained in the queue 26 until printer 16 is returned to an operative state (step 60). If the print job is time sensitive, queue manager 28 determines whether the print job has expired (step 62). In doing so, queue manager 28 communicates with server clock 30 to identify the duration of the printer malfunction and compares that duration to the expiration data for the time sensitive print job. If the print job has expired, queue manager 28 purges the print job from the queue 26 and informs a user that the print job has been purged and must be resent for printing (step 66). If the print job has not expired, it is retained in queue 26, and the process repeats with step 54.

The steps of FIG. 3 can be further employed to recovery feature 32, memory manager 34, and printer memory 40 depicted in FIG. 2. For example, mentioned here but not depicted in the figures, the print job is stored in printer memory 40 (step 52) as recovery feature 32 assesses printer 16 for malfunction (step 54). If the assessment reveals printer 16 to be operative, the print job is sent to memory manager 34 which carries out directions from recovery feature 32 to send the print job to the print engine 36 for printing and to purge the print job from printer memory 40 (step 56). However if printer 16 is assessed to be malfunctioning, recovery feature 32 determines if the print job is time sensitive (step 58). If not time sensitive, the print job is retained in the printer memory 40 until printer 16 is returned to an operative state (step 60). If the print job is time sensitive, recovery feature 32 assesses whether the print job has expired (step 62). In doing so, recovery feature 32 communicates with clock 38 to identify the duration of the printer malfunction and compares that duration to the expiration data for the time sensitive print job. If the print job has expired, recovery feature 32 instructs memory manager 34 to purge the print job from the printer memory 40 (step 64), and to inform a user that the print job has been purged and must be resent for printing (step 66). If the print job has not expired, it is retained in printer memory 40, and the process repeats with step 54.

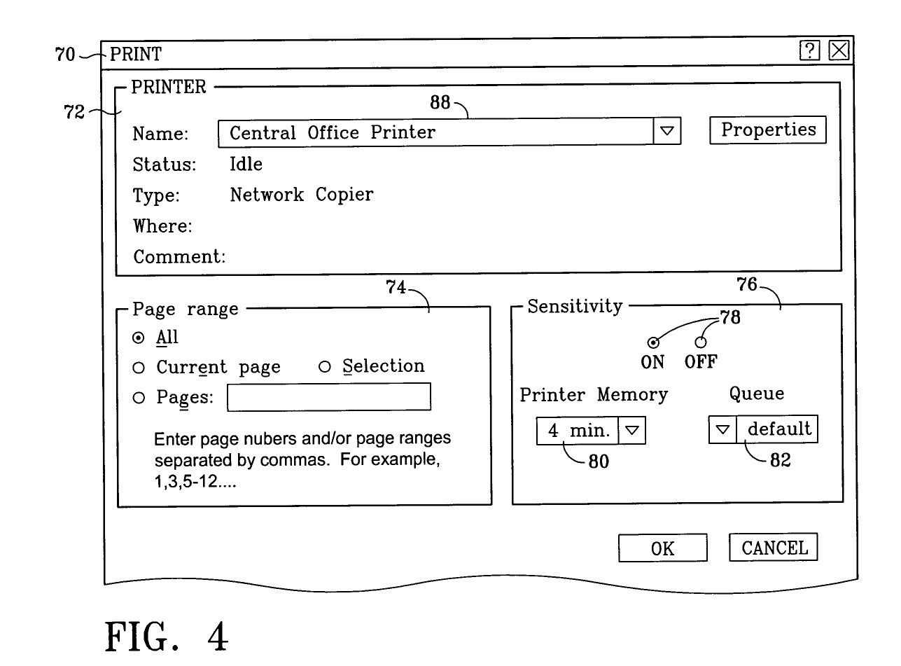

EXAMPLE: FIG. 4 is an exemplary screen view of a user interface 70 generated by driver 24 in response to receiving printing instructions from application 22 (shown in FIG. 2). Interface 70 includes a number of user accessible controls separated into groups 72, 74, and 76. Printer group 76 includes controls for identifying a printer. Here, “Central Office Printer” is selected. Page range group 74 includes controls for selecting the specific pages to be printed.

Sensitivity group includes controls 78, 80, and 82 for identifying a print job as time sensitive and for specifying expiration data. Controls 78 are radio buttons that when selected either turn sensitivity on or off—in other words—allow a user to specify whether a print job is to be designated as time sensitive or not. Control 80 is a pull down menu that allows a user to set expiration data relating to a duration the print job is to remain in printer memory following a triggering event such as a printer malfunction. In this example, the print job is purged from printer memory if a printer malfunction is not remedied within four minutes. Control 82 is a pull down menu that allows a user to select expiration data relating to a maximum duration the print job is to remain in a queue without regard to a malfunction. Here, no duration has been selected, so a default duration will be applied.

CONCLUSION: Although the flow chart of FIG. 3 shows a specific order of execution, the order of execution may differ from that which is depicted. For example, the order of execution of two or more blocks may be scrambled relative to the order shown. Also, two or more blocks shown in succession may be executed concurrently or with partial concurrence. All such variations are within the scope of the present invention. Moreover, the exemplary screen view of FIG. 4 is just that, exemplary.

The present invention can be embodied in any computer-readable media for use by or in connection with an instruction execution system such as a computer/processor based system or other system that can fetch or obtain the logic from the computer-readable media and execute the instructions contained therein. A “computer-readable medium” can be one or more media that can contain, store, or maintain programming for use by or in connection with the instruction execution system. The computer readable medium can comprise any one or more of many physical media such as, for example, electronic, magnetic, optical, electromagnetic, infrared, or semiconductor media. More specific examples of a suitable computer-readable medium would include, but are not limited to, a portable magnetic computer diskette such as a floppy diskette or hard drive, a random access memory (RAM), a read-only memory (ROM), an erasable programmable read-only memory, a portable compact disc, or any combination thereof.

The present invention has been shown and described with reference to the foregoing exemplary embodiments. It is to be understood, however, that other forms, details, and embodiments may be made without departing from the spirit and scope of the invention, which is defined in the following claims.

1. A computer readable medium having instructions for determining if a print job designated time sensitive has expired following a triggering event and purging the print job from a memory upon determining the print job has expired.

2. The medium of claim 1, wherein the print job designated time sensitive includes expiration data and wherein the instructions for purging the print job from a memory upon determining the print job has expired include instructions for:
detecting a triggering event;
comparing a time elapsed following the triggering event with a duration specified by the expiration data; and
purging the print job if the time elapsed exceeds the duration specified by the expiration data.

3. The medium of claim 2, wherein the instructions for detecting a triggering event include instructions for detecting a malfunction.

4. The medium of claim 2, wherein the instructions for detecting a triggering event include instructions for detecting the placement of the print job in the memory.

5. A computer readable medium having instructions for:
determining if a print job stored in a memory has been designated time sensitive following a triggering event; and
if the print job has been designated time sensitive, obtaining expiration data for the print job, and, if the print job has expired according to the expiration data, purging the print job from the memory.

6. The medium of claim 5 having further instructions for detecting a triggering event and comparing a time elapsed following the triggering event with a duration specified by the expiration data to determine if the print job has expired.

7. The medium of claim 5, wherein the memory is a printer memory and wherein:
the instructions for obtaining expiration data include instructions for obtaining expiration data relating to a duration that the print job is to be held in the printer memory; and
the instructions for purging include instructions for purging the print job from the printer memory.

8. The medium of claim 5, wherein the memory is a queue and wherein:
the instructions for obtaining expiration data include instructions for obtaining expiration data relating to a duration that the print job is to be held in the queue; and
the instructions for purging include instructions for purging the print job from the queue.

9. A computer readable medium having instructions for:
receiving instructions from an application to print an electronic document;
translating the instructions into a print job;
presenting a user interface having user accessible controls for designating the print job as time sensitive and for specifying expiration data; and
if so selected through the interface, designating the print job as time sensitive and including expiration data with the print job.

10. The medium of claim 9, wherein the instructions for presenting include instructions for presenting a user interface having user accessible controls for designating the print job as time sensitive and for specifying expiration data relating to a first duration for holding the print job in printer memory and a second duration for holding the print job in a queue.

11. A computer readable medium having instructions for:
identifying a malfunction that prevents a print job stored in a memory from being printed;
upon identifying the malfunction, determining if the print job has expired; and
if expired, purging the print job from the memory.

12. The medium of claim 11 having further instructions for determining if the print job has been designated as a time sensitive, and wherein the instructions for purging include instructions for purging the print job only if it has been designated as a time sensitive print job.

13. The medium of claim 11 wherein the memory is a queue and wherein the instructions for purging include instructions for purging the print job from the queue.

14. The medium of claim 11 wherein the memory is a printer memory and wherein the instructions for purging include instructions for purging the print job from the printer memory.

15. The medium of claim 11 having further instructions for notifying a user if the print job has been purged.

16. A method for purging a print job, comprising determining if a print job designated as time sensitive has expired following a triggering event and purging the print job from a memory upon determining the print job has expired.

17. The method of claim 16, wherein the print job designated time sensitive includes expiration data and wherein purging the print job from a memory upon determining the print job has expired comprises:
detecting a triggering event;
comparing a time elapsed following the triggering event with a duration specified by the expiration data; and
purging the print job if the time elapsed exceeds the duration specified by the expiration data.

18. The method of claim 17, wherein detecting a triggering event comprises detecting a malfunction.

19. The method of claim 17, wherein detecting a triggering event comprises detecting the placement of the print job in the memory.

20. A method for purging a print job, comprising:
determining if a print job stored in a memory has been designated time sensitive;
if the print job has been designated time sensitive and a triggering event has occurred, obtaining expiration data associated with the print job, determining if the print job has expired, and, if the print job has expired according to the expiration data, purging the print job from the memory.

21. The method of claim 20, further comprising detecting a triggering event and comparing a time elapsed following the triggering event with a duration specified by the expiration data to determine if the print job has expired.

22. The method of claim 20, wherein the memory is a printer memory and wherein:
obtaining expiration data comprises obtaining expiration data relating to a duration that the print job is to be held in the printer memory; and
purging comprises purging the print job from the printer memory.

23. The method of claim 20, wherein the memory is a queue and wherein:
obtaining expiration data comprises obtaining expiration data relating to a duration that the print job is to be held in the queue; and
purging comprise purging the print job from the queue.

24. A method for designating a print job as time sensitive, comprising:
receiving instructions from an application to print an electronic document;
translating the instructions into a print job;
presenting a user interface having user accessible controls for designating the print job as time sensitive and for specifying expiration data; and
if so selected through the interface, designating the print job as time sensitive and including expiration data with the print job.

25. The method of claim 24, wherein presenting comprises presenting a user interface having user accessible controls for designating the print job as time sensitive and for specifying expiration data relating to a first duration for holding the print job in printer memory and a second duration for holding the print job in a queue.

26. A method for purging a print job, comprising:
identifying a printer malfunction that prevents a print job stored in a memory from being printed;
upon identifying the malfunction, determining if the stored print job has expired; and
if expired, purging the print job from the memory.

27. The method of claim 26 further comprises:
determining if the print job has been designated as time sensitive; and
purging the print job only if it has been designated as a time sensitive print job.

28. The method of claim 26 wherein the memory is a queue, and wherein purging the print job includes purging the print job from the queue.

29. The method of claim 26, wherein the memory is a printer memory, and wherein purging the expired print job includes purging the expired print job from the printer memory.

30. The method of claim 26, further comprising notifying a user that the print job has been purged.

31. A method for purging a print job, comprising:
designating the print job as a time sensitive print job;
queuing the time sensitive print job;
detecting a malfunction that prevents the time sensitive print job from being printed; and
purging the time sensitive print job if the malfunction is not remedied within a set time.

32. The method of claim 31, further comprising:
sending the queued time sensitive print job to a printer memory;
detecting a malfunction that prevents the time sensitive print job in the printer memory from being printed; and
purging the printer memory of the time sensitive print job if the malfunction is not remedied within a set time.

33. The method of claim 31, further comprising notifying a user if the print job has been purged.

34. The method of claim 31, further comprising associating expiration data with the time sensitive print job, and after detecting the malfunction using the expiration data to determine if the time sensitive print job has expired, and wherein purging comprises purging the time sensitive print job only if it has expired.

35. A system for printing, comprising:
an application capable of instructing an electronic document to be printed; and
a driver capable of translating printing instructions from an application into a print job and of allowing a user to designate the print job as time sensitive and to specify expiration data for the print job.

36. A print server, comprising:
a queue for temporarily holding a print job; and
a queue manager capable of determining if the print job held in the queue is time sensitive, and, if time sensitive, determining if the print job has expired, and purging the print job from the queue if the time sensitive print job has expired.

37. The print server of claim 36, wherein the print job is time sensitive and includes expiration data and wherein the queue manager is operable to determine if the print job has expired by:
detecting a triggering event; and
comparing a time elapsed following the triggering event with a duration specified by the expiration data.

38. The server of claim 37 wherein the triggering event is a malfunction.

39. The server of claim 37 wherein the triggering event is a placement of the print job in the queue.

40. An image forming device, comprising:
a print engine capable of printing information on print media;
a memory manager capable of storing a print job in a memory, routing the print job from the memory to the print engine, and purging the print job from the memory; and
a recovery feature capable of identifying whether the print job held in the memory is time sensitive, and, if time sensitive and if a triggering event has occurred, determining if the print job has expired, and instructing the memory manager to purge the print job from the memory if the time sensitive print job has expired.

41. The device of claim 40, wherein the print job is time sensitive and includes expiration data and wherein the recovery feature is operable to determine if the print job has expired by:
detecting a triggering event; and
comparing a time elapsed following the triggering event with a duration specified by the expiration data.

42. The device of claim 41 wherein the triggering event is a malfunction.

43. An image forming device, comprising:
a memory for storing a print job;
a print engine capable of printing information on print media;
a memory manager capable of storing the print job in the memory, routing the print job from the memory to the print engine, and purging the print job from the memory; and
a recovery feature capable of identifying a printer malfunction, identifying whether the print job held in the memory is time sensitive, and, if time sensitive, instructing the memory manager to purge the print job from the memory if the time sensitive print job expires before the malfunction is remedied.

44. A printer driver, comprising:
a means for receiving instructions from an application to print an electronic document;
a means for translating the instructions into a print job;
a means for presenting a user interface having user accessible controls for designating the print job as time sensitive and for specifying expiration data; and
a means for designating the print job as time sensitive and including expiration data with the print job if so selected through the interface.

45. A system for purging a print job, comprising:
a means for storing the print job in memory;
a means for identifying a printer malfunction that prevents the stored print job from being printed;
a means for determining, upon identifying the malfunction, if the stored print job has expired; and
a means for purging the print job, if expired, from memory.
